(19) United States
(12) Patent Application Publication
(10) Pub. No.: US 2012/0049707 A1
(43) Pub. Date: Mar. 1, 2012

(54) LIGHT-TIGHT IMAGING ASSEMBLY

(75) Inventors: Michael B. Nelson, Tucson, AZ (US); Joshua Ludeke, Tucson, AZ (US)

(73) Assignee: SPECTRAL INSTRUMENTS IMAGING, LLC, Tucson, AZ (US)

(21) Appl. No.: 13/222,661

(22) Filed: Aug. 31, 2011

Related U.S. Application Data
(60) Provisional application No. 61/379,277, filed on Sep. 1, 2010.

(51) Int. Cl. E06B 7/16; B23P 11/00; A47B 96/00

(52) U.S. Cl. 312/237; 49/70; 29/428

(57) ABSTRACT

A light-tight door assembly may include a door with a leading side and a non-leading side. The door may be mounted to an enclosure so that the door can be translated with respect to an opening in the enclosure between an opened position and a closed position. A first flange member may be mounted to the non-leading side of the door and a second flange member may be mounted to the enclosure so that the second flange member cooperates with, but does not contact, the first flange member when the door is in the closed position. The non-contact cooperation of the first and second flange members forms a substantially light-tight seal when the door is in the closed position.

### CROSS-REFERENCE TO RELATED APPLICATION

This application claims the benefit of U.S. Provisional Patent Application No. 61/379,277, filed on Sep. 1, 2010, which is hereby incorporated herein by reference for all that it discloses.

### TECHNICAL FIELD

This invention relates to methods and apparatus for closing an imaging assembly, more specifically for methods and apparatus for closing an imaging chamber with a light-tight seal.

### BACKGROUND

In molecular imaging systems, which are well-known, light emitted from an object. or specimen is captured by a sensitive camera (e.g., charge coupled device (CCD) camera) so that aspects of the object or specimen can be analyzed. In the case of bioluminescence, chemiluminescence and other fluorescence processes, the amount of light emitted by the object or specimen is extremely low. Thus, it is important that the imaging environment, such as an imaging chamber, be configured to block out ambient light to minimize or even eliminate the signal interference that it causes.

### SUMMARY OF THE INVENTION

According to one embodiment of the present invention, a light-tight door assembly for closing an opening defined in an enclosure may comprise a door having at least one leading side and a non-leading side. The door may be mounted to the enclosure so that the door can be translated with respect to the opening between an opened position and a closed position. A first flange member may be mounted to the non-leading side of said door. A second flange member may be mounted to the enclosure so that the second flange member cooperates with, but does not contact, the first flange member when the door is in the closed position. The non-contact cooperation of the first and second flange members forms a substantially light-tight seal when the door is in the closed position.

In another embodiment of the present invention, an assembly comprises an enclosure that has at least one opening defined in the enclosure; a guide member mounted to the enclosure; a door that has at least a leading side and a non-leading side mounted to the guide member so that the door can be translated with respect to the opening between an opened position and a closed position; a first flange extending from the non-leading side of said door; and a second flange extending from the enclosure so that the second flange cooperates with, but does not contact, the first flange when the door is in the closed position such that the non-contact cooperation of the first and second flanges form a substantially light-tight seal when said door is in the closed position.

### BRIEF DESCRIPTION OF THE DRAWINGS

Illustrative and presently preferred exemplary embodiments of the invention are shown in the drawings in which:

FIG. 1 is a perspective view of an imaging assembly of the present invention;

FIG. 2 is a perspective view of an embodiment of a light-tight door assembly including a mounting plate;

FIG. 3 is a perspective view of an embodiment of the light-tight door assembly of the present invention including door slides;

FIG. 4 is another perspective view of the embodiment of the light-tight door assembly shown in FIG. 3;

FIG. 5 is an isometric view of an embodiment of the support structure enclosure, including imaging chamber, access opening to the imaging chamber, access opening flange and door flange;

FIG. 6 is an enlarged view of the access opening and imaging chamber of the support structure enclosure embodiment of FIG. 5;

FIG. 7 is perspective view of an embodiment of the door flange of the light-tight door assembly;

FIG. 8 is perspective view of an embodiment of the support structure enclosure, including imaging chamber, access opening to the imaging chamber, and access opening flange;

FIG. 9 is a perspective view of the access opening flange;

FIG. 10 is an enlarged view of the embodiment of the support structure enclosure shown in FIG. 8 (but without a wellplate), showing an access opening member and door skirt;

FIG. 11 is a cross-sectional view of the imaging assembly of the present invention in which the cross section was taken at line A-A′ as shown in FIG. 5;

FIG. 12 is an enlarged view of box “B” as shown in FIG. 11, including door flange and access opening flange;

FIG. 13 is an enlarged view of portions of the mounting system and counterbalance system of an embodiment of the present invention; and

FIG. 14 is an enlarged view of portions of the mounting system and counterbalance system of an embodiment of the present invention.

### DETAILED DESCRIPTION OF THE PREFERRED EMBODIMENTS

Imaging applications may require an imaging chamber that is substantially light-tight. When the imaging chamber is free from unwanted ambient or external light, the imaging apparatus can perform efficiently for its intended purpose in certain types of biomedical imaging (e.g., bioluminescence and/or fluorescence processes) in which low levels of light are emitted by the object or specimen being imaged. Achieving a substantially light-tight imaging chamber may depend on how securely a door covering an opening to the imaging chamber may be closed. Prior art systems using gasket seals and hinged doors have their limitations in that the doors may be difficult to close or open, may create a safety hazard by protruding too far into the workspace when open, and may not consistently achieve substantially light-tight environments. The present invention for an imaging assembly 10, however, achieves a substantially light-tight imaging environment by using light-tight door assembly 12 that is easy to open and close and that creates an effective seal against unwanted light.

The present invention comprises light-tight door assembly 12 for imaging assembly 10. The imaging assembly 10 of the present invention comprises light-tight door assembly 12, support structure enclosure 14, imaging equipment 16, mounting system 18, latch system 34 and counterbalance system 20. Together, support structure enclosure 14, light-tight door assembly 12 and the mounting system 18 cooperate to substantially prevent unwanted ambient or external light from entering imaging chamber 22 of support structure enclosure 14 when door 24 of the light-tight door assembly 12 is in the closed position, as may be required for certain types of imaging, such as bioluminescence imaging or fluorescence imaging.

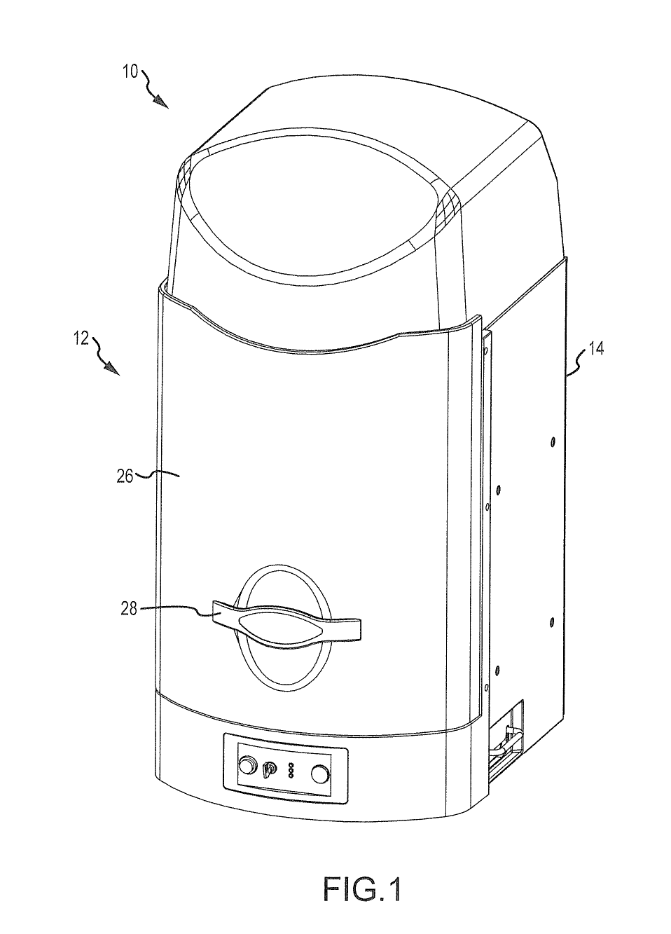

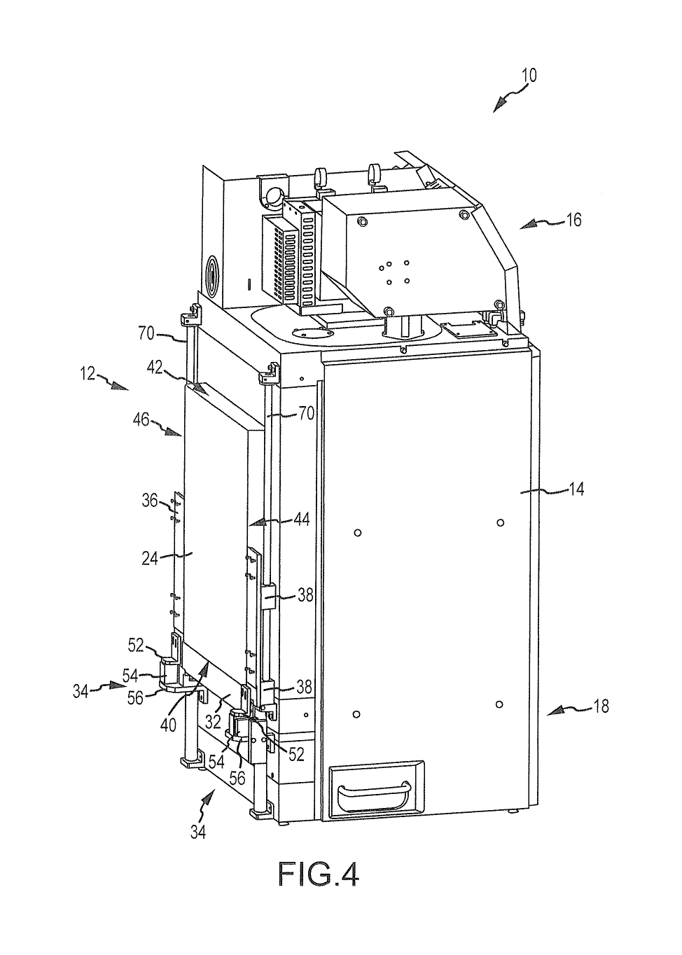

The light-tight door assembly 12 will now be discussed with reference to an embodiment illustrated in FIGS. 1-7, starting with the door 24 in the closed position, and thereafter removing components of the light-tight door assembly 12 until imaging chamber 22 of support structure enclosure 14 is reached.

FIG. 1 shows the light-tight door assembly 12 in the closed (lowered) position. Door cover 26, through which door handle 28 protrudes, protects the inner workings of light-tight door assembly 12.

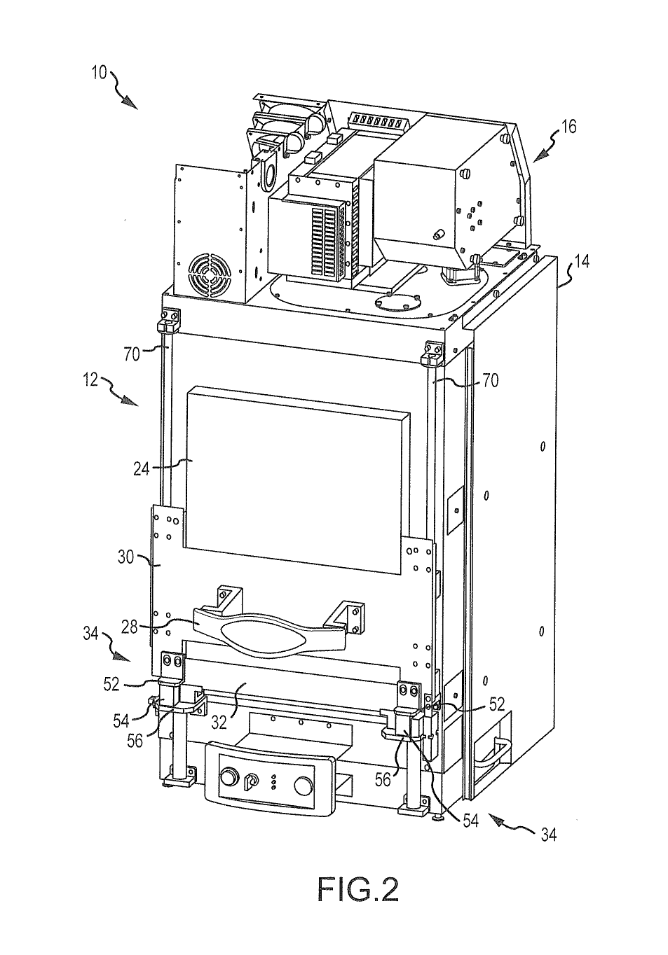

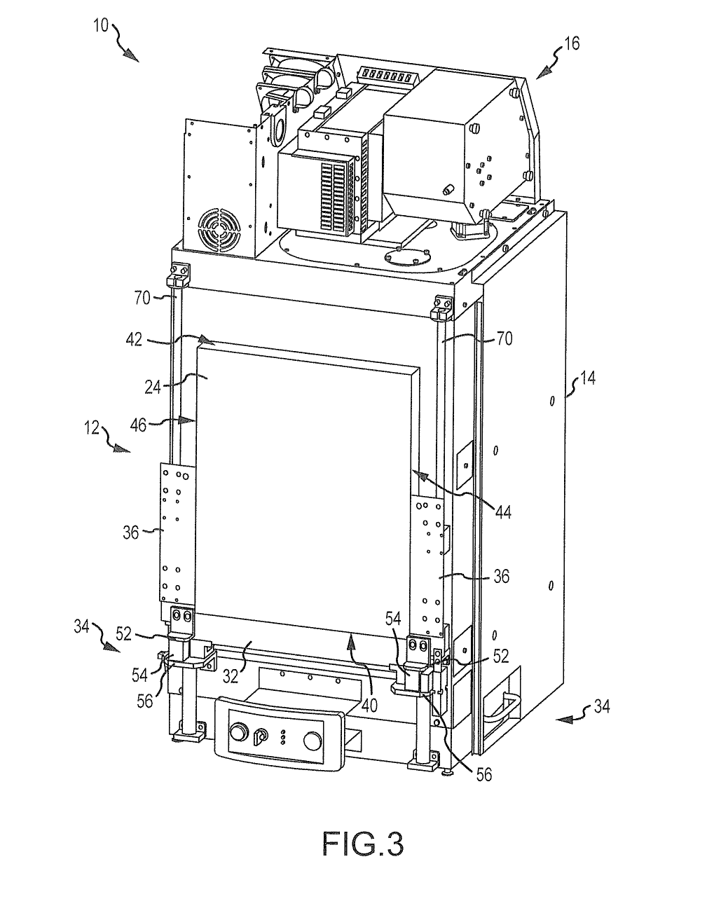

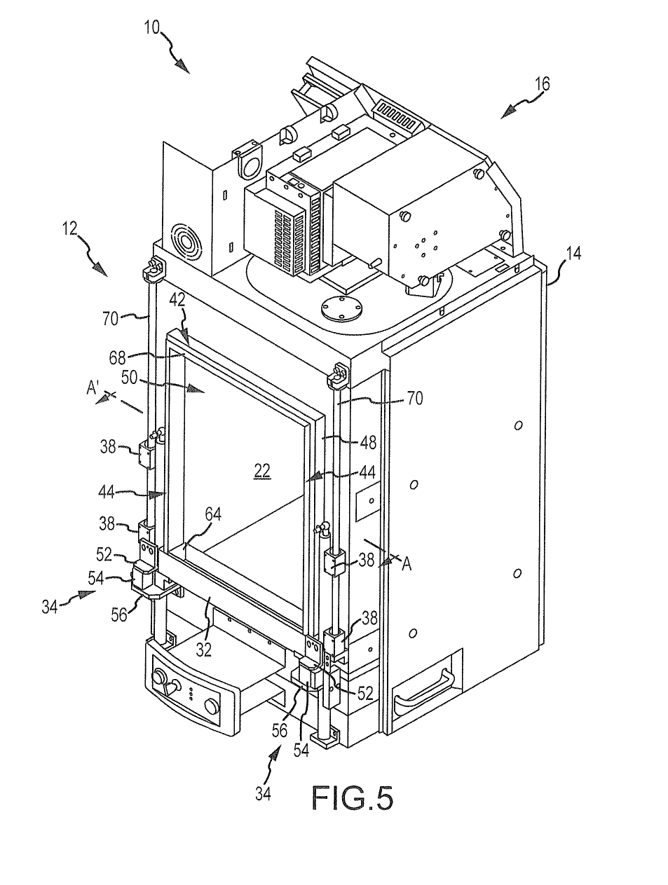

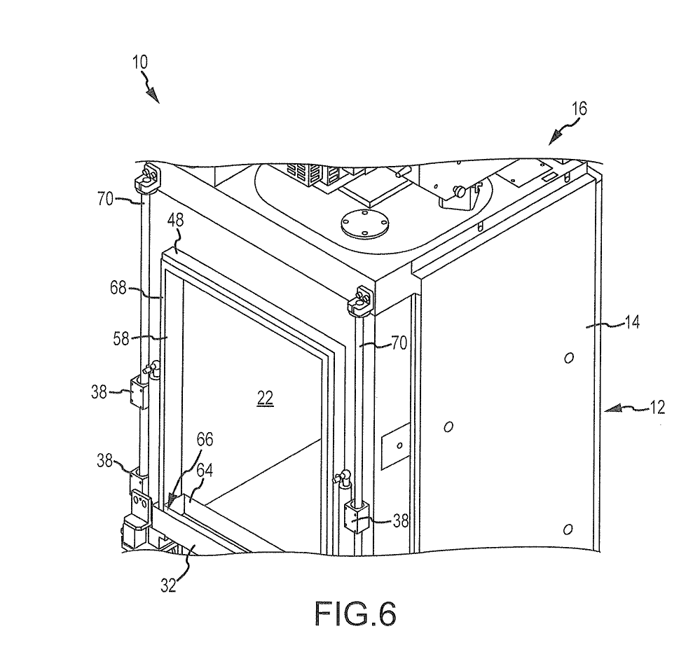

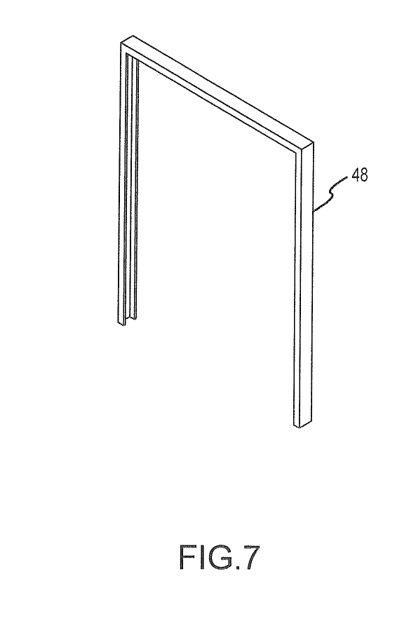

Once door cover 26 is removed, it can be seen that light-tight door assembly 12 comprises generally door 24, mounting plate 30, door slides 36 and door flange 48. In the embodiment shown in FIGS. 2-7, door 24 comprises a C-shaped cross-section and has a leading side 40, and three non-leading sides 42, 44, 46. As used herein, “C-shaped” means that the component when viewed in cross-section has the shape of the letter “C.” Leading side 40 is the side of door 24 that leads the motion of the light-tight door assembly 12 as it translates from the open to the closed position. The first non-leading side 42 (second side) is opposite the leading side, as shown in FIG. 3. The second and third non-leading sides 44, 46 are perpendicular to the leading side 40. The door 24 is also attached to door flange 48. As can be seen in the embodiment shown in FIG. 7, door flange 48 is C-shaped also, but the orientation of the C-shape of door flange 48 is different from that of door 24. As shown in the embodiment in FIGS. 5-6, door flange 48 is attached to and extends from the three non-leading sides 42, 44, 46 of door 24, facing access opening 50 of support structure enclosure 14. FIGS. 5 and 6 show the position of door flange 48 as attached to door 24; however, door 24 is not shown so that the door flange 48 and other components normally covered by door 24 can be seen.

In an embodiment of the present invention shown in FIGS. 2-7, also mounted to door 24 on the second and third non-leading sides are door slides 36. Door slides 36 are mounted to an underside of mounting plate 30, as well as to linear bearings 38, which are part of mounting system 18. Mounting plate 30 in combination with door slides 36 support door 24. Thus, the door 24 may be thinner and otherwise more flexible than would be required if the door 24 supported itself.

Mounting plate 30 also supports door handle 28 which is affixed to the mounting plate 30 as shown in FIGS. 1-2. Door cover 26 fits over the mounting plate 30 and door 24, allowing the door handle 28 to protrude through the door cover 26. Other systems for mounting the door handle 28 and covering the inner workings of the door 24 may also be used.

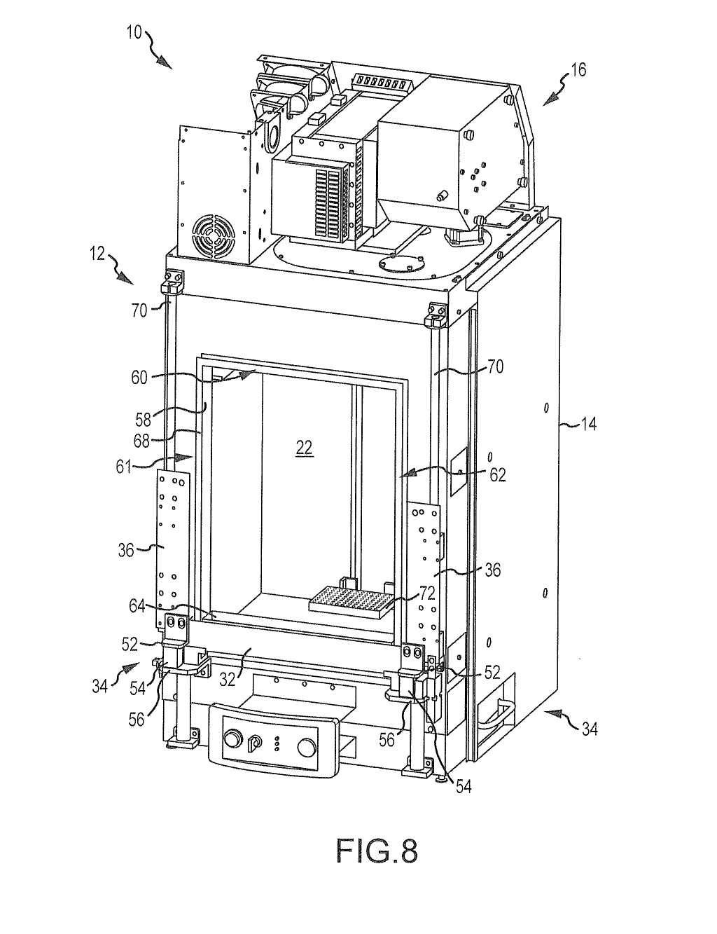

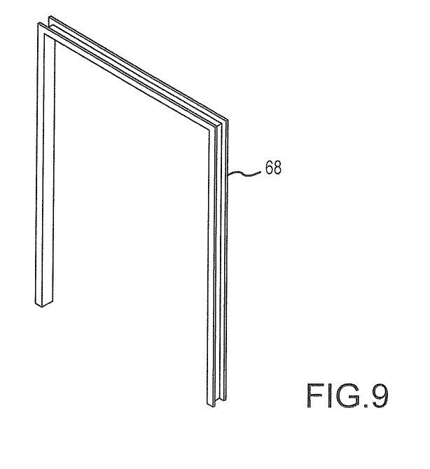

The support structure enclosure 14 of the present invention will now be described with reference to FIGS. 6 and 8-10. The support structure enclosure 14 comprises imaging chamber 22 and access opening 50 through which an object (e.g., wellplate 72) or specimen (e.g., mouse) to be imaged may be placed in imaging chamber 22. Imaging equipment 16 is mounted to the top of support structure enclosure 14 in a position that allows imaging equipment 16 to capture light emitted from the specimen or wellplate 72. To allow the specimen or wellplate 72 to be placed in imaging chamber 22, support structure enclosure 14 further comprises access opening 50 having a frame 58 with a top edge 60, two side edges 61, 62 and a bottom edge. See FIGS. 6, 8. As will be explained in more detail below, mounted to and protruding from the exterior of frame 58 is access opening flange 68 which is configured to cooperate with door flange 48 included in light-tight door assembly 12. See FIG. 8. In the embodiment shown in FIG. 9, access opening flange 68 is C-shaped.

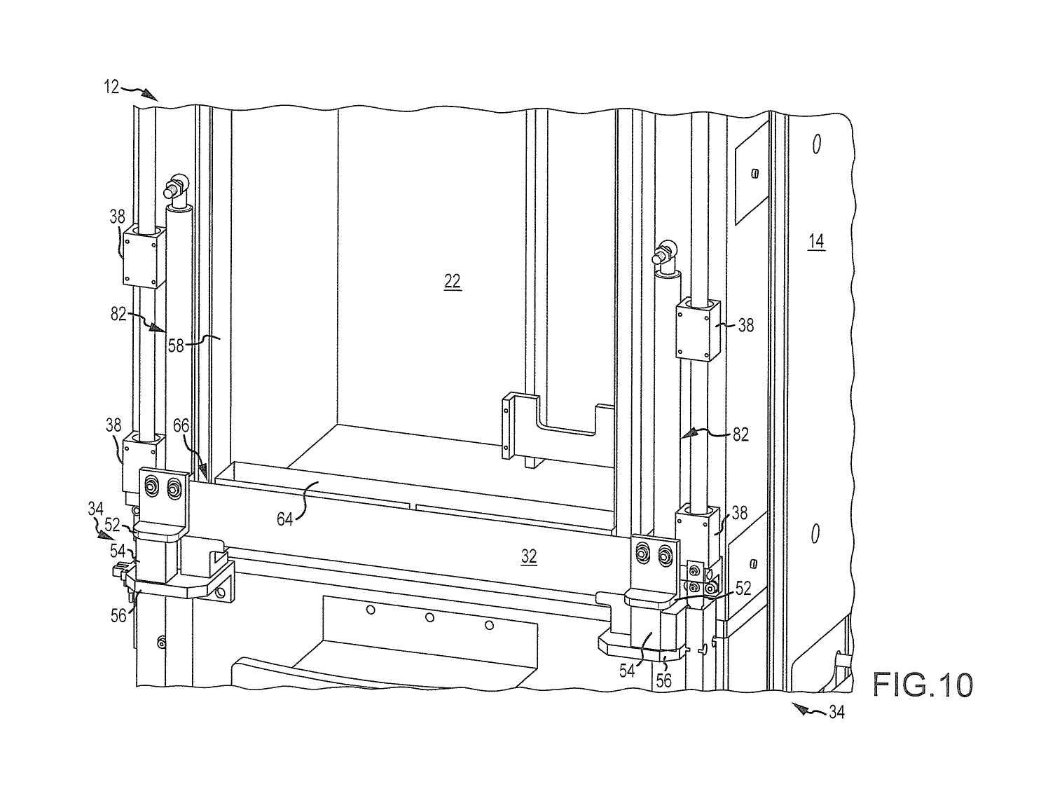

Support structure enclosure 14 also comprises access opening member 64 and door skirt 32. Covering the bottom edge of access opening 50 is access opening member 64. In the embodiment shown in FIGS. 6, 8 and 10, access opening member 64 is rectangular in shape in the form of an open box that, in its shortest dimension, spans the width of door frame 58, and in its longest dimension, spans the width of access opening 50 along the bottom edge. Access opening member 50 is separated from the door skirt 32 by a spaced interval, or first gap 66, as shown in FIGS. 6 and 10. In addition, as can be seen in FIG. 10, door skirt 32 is also C-shaped and wraps around the first side and second side edges 61, 62 of door frame 58 at the spaced interval, continuing the extent of first gap 66. Thus, first gap 66 is C-shaped; first gap 66 is of a size and shape to receive door 24, which, as previously mentioned is also C-shaped. In the embodiment shown, first gap 66 is less than about 2.5 mm (about 0.1 inches) wide, but the invention should not be viewed as being limited to any particular dimension. In the closed position, door 24 slides into gap 66.

In another embodiment (not shown), a bottom flange may be mounted to the bottom edge of access opening 50. In that embodiment, the bottom flange may be a “plain” flange or extension that protrudes from the from the bottom edge of the access opening 50, but with sufficient clearance to permit door 24 to close over the bottom flange without touching it, forming a bottom gap, or leading edge door gap, between the door and the bottom flange. In another embodiment, the door 24 may include an extended lip portion so that the third flange is completely covered by door 24. In one embodiment, the leading edge door gap may be less than about 2.5 mm (0.1 inches) wide; however, the invention should not be viewed as being limited to any particular dimension.

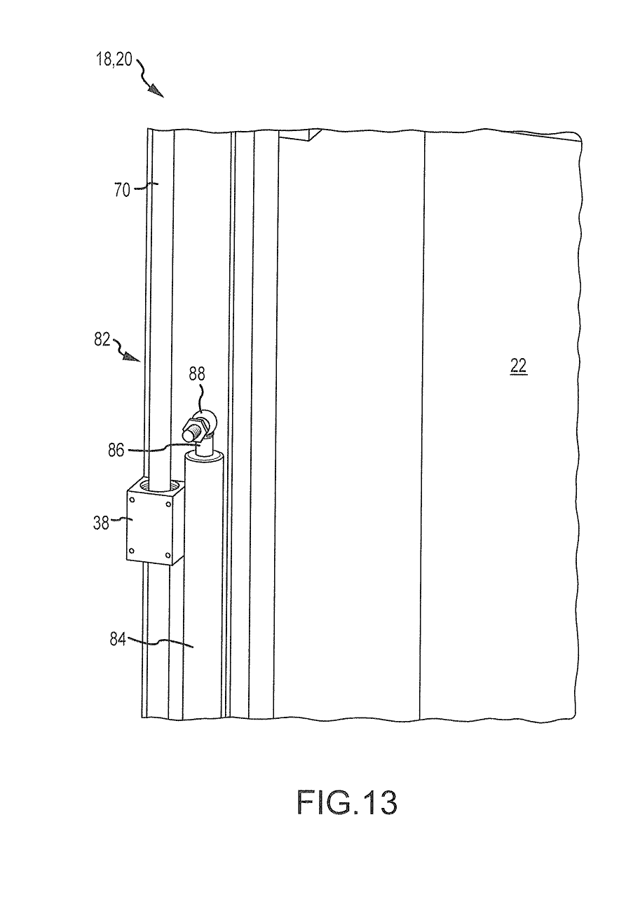

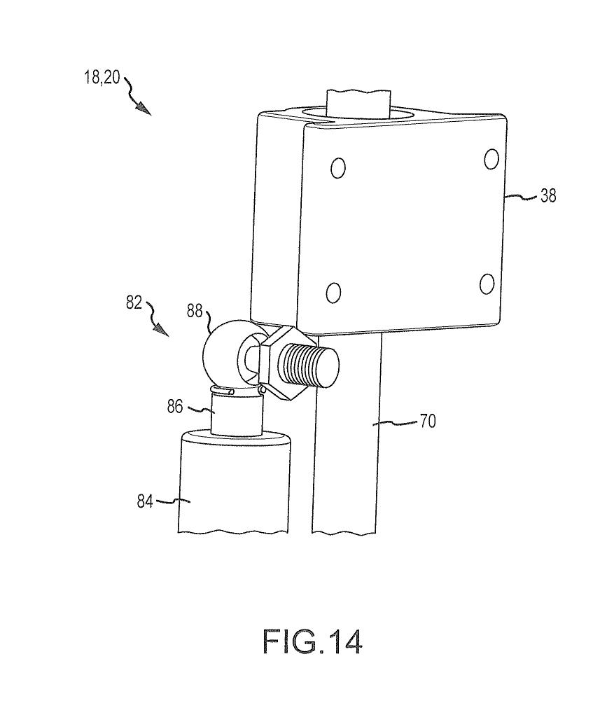

In the embodiment shown in FIGS. 2-6 and 10-14, to cover access opening 50 to imaging chamber 20, light tight door assembly 12 is mounted to support structure enclosure 14 using mounting system 18, which comprises guide shaft 70 and linear bearing 38. As shown, guide shafts 70 are attached to support structure enclosure 14 on the outside of imaging chamber 20, adjacent first side edge 61 and second side edge 62 of access opening 50, thereby permitting the light-tight door assembly 12 to translate vertically from the open to the closed position. Guide shafts 70 are inserted through linear bearings 38, which, in the embodiment shown, have a bore diameter of about 12.7 mm (about 0.5 inches). Linear bearings 38 are attached to door slides 36, which, as mentioned are in turn attached to mounting plate 30. Since mounting plate 30 is attached to door 24, connecting the door slides 36 to the linear bearings 38 allows the door 24 to move along the guide shafts 58, thereby causing door 24 (and light-tight door assembly 12) to translate vertically along the guide shafts 70 from the open position to the closed position, and vice versa. In addition, by mounting door 24 to the mounting plate 30, the door 24 and door flange 48 may be aligned with both access opening flange 68 and first gap 66 without having to adjust guide shafts 70.

In another embodiment in which the door 24 translation is horizontal, the configuration of the guide shafts 70 would be different to allow the light-tight door assembly 12 to translate horizontally from the open to the closed position. In that embodiment, the guide shafts 70 would be oriented horizontally and mounted adjacent to the top 60 and bottom edges of access opening 50; however, a plurality of guide shafts 70 may not be required. The configuration of linear bearings 38, door slides 36, mounting plate 30, door handle 28 would be adjusted accordingly as would be familiar to one of ordinary skill in the art after becoming familiar with the teachings of the present invention.

The manner in which the light-tight door assembly 12 forms a light-tight seal as it translates from the open to the closed position will now be described. As described above, briefly, both the access opening 50 (e.g., frame 58) and door 24 are equipped with cooperating flanges, door flange 48 and access opening flange 68, which may be separate components or integral to door 24 and access opening 50, respectively. In addition, access opening 50 is also equipped with means for forming the light tight seal between the bottom edge of access opening 50 and leading side 40 of door 24.

In an embodiment shown in FIGS. 5-9 and 11-12, door 24 is equipped with door flange 48 and access opening 50 is equipped with access opening flange 68. Door flange 48 is C-shaped and is affixed to and protrudes from the first, second and third non-leading sides 42, 44, 46 of door 24. No flange is affixed to leading side 40 of door 24 in the embodiment shown, although other configurations are possible. Access opening flange 68 is also C-shaped and is affixed to and protrudes from the top edge 60 and side edges 61, 62 of access 50. In the embodiment shown, C-shaped gap 66 for receiving the C-shaped leading side 40 of door 24 is formed at the bottom edge of access opening 50 by access opening member 64 and door skirt 32, as may be best seen in FIG. 10.

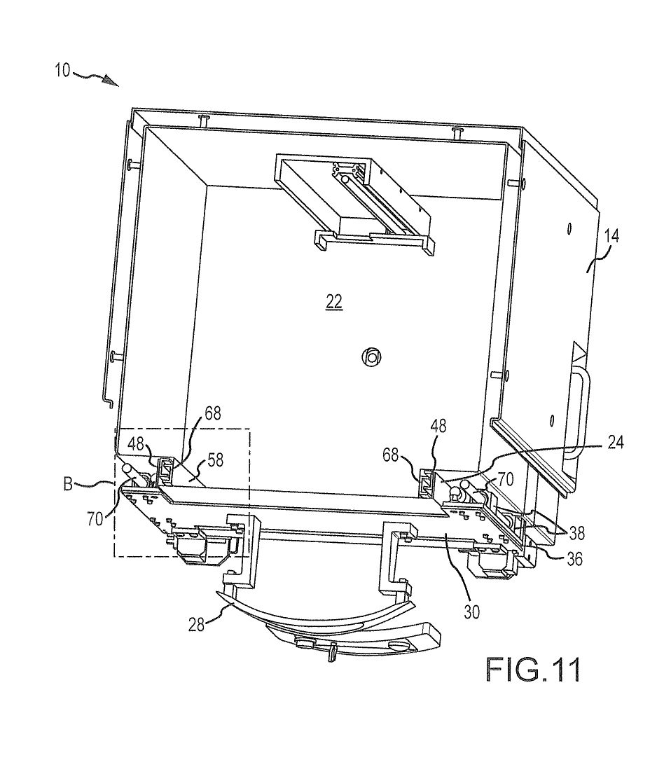

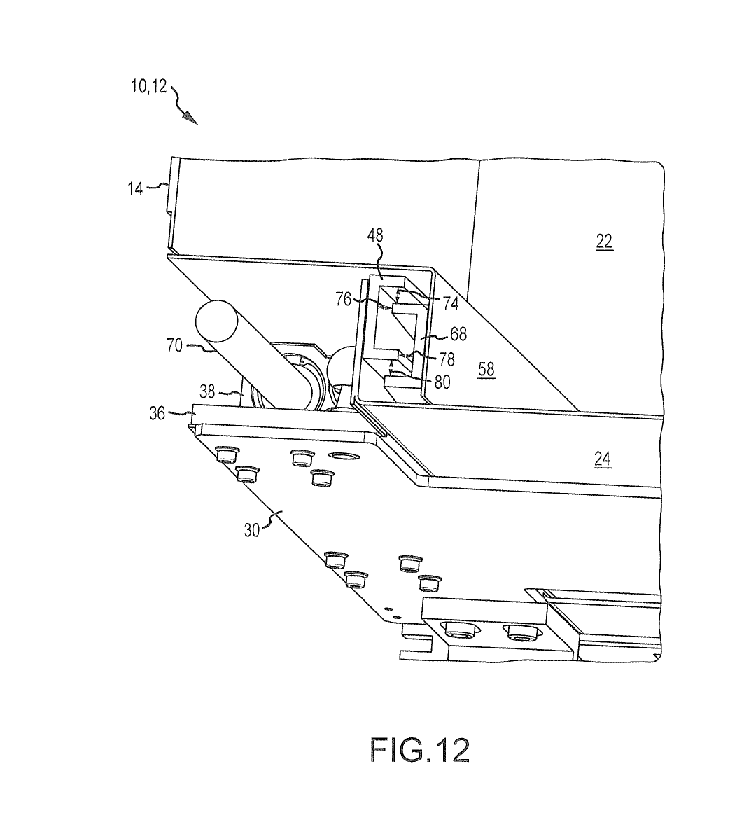

The door flange 48 and access opening flange 68 are configured in relation to one another so that their mirror “C” shapes cooperate and interlock in a nested arrangement (i.e. without contact between them) when the door assembly is in the closed position, as may be seen in FIGS. 11-12, forming the non-contacting substantially light-tight seal. Thus, to allow the light-tight door assembly 12 to translate from the open (raised) position to the closed (lowered) position along the guide shafts 70, the interlocking relationship between the C shapes of door flange 48 and access opening flange 68 creates a series of gaps between door flange 48 and access opening flange 68, as can be seen in the embodiment shown in FIGS. 11 and 12. The series of non-contacting gaps comprise second 74, third 76, fourth 78 and fifth 80 gaps. As shown in FIG. 12, the second 74, third 76, fourth 78 and fifth 80 gaps formed between door flange 48 and access opening flange 68 may be less than about 2.5 mm (about 0.1 inches) wide to form the non-contacting, substantially light-tight seal. Gaps of other dimensions are also possible depending on the size of the image assembly, as would be familiar to one of ordinary skill in the art after becoming familiar with the teachings of the present invention; thus, the present invention should not be viewed as being limited in that respect.

In other embodiments of the present invention, the shape and orientation of the interlocking, non-contacting, cooperating flange members may be varied as would be familiar to one of ordinary skill in the art so long as the flanges cooperate to form the substantially light-tight seal without contact between them. For example, the position of the door flange 48 and the access opening flange 68 could be changed. Or, in another embodiment, H-shaped flanges could be used, for example.

In the embodiment shown in FIGS. 6 and 10, the light-tight seal is also formed from the interplay of the cooperating C-shapes of door 24 and first gap 66. As mentioned above, and as seen in FIGS. 6 and 10, access opening member 64 is positioned at the bottom edge, with its shortest dimension spanning the width of door frame 58, and its longest dimension spanning the width of access opening 50 along the bottom edge. Door skirt 32, which is C-shaped and wraps around first and second side edges 61, 62 of frame 58, is positioned substantially parallel to access opening member 64 and separated from it by first gap 66. Thus, first gap 66 is also C-shaped and is of a size and shape to receive door 24, thereby forming the light-tight seal when the C-shaped leading side 40 of door 24 is inserted in the C-shaped first gap 66.

In another embodiment, the light-tight seal at the leading side 40 of door 24 may be achieved by means of the third flange that may be affixed to and may protrude from the bottom edge of access opening 50, but with clearance sufficient to allow the door 24 to close over the third flange without contacting it, thus creating the substantially light-tight seal. In another embodiment, the door 24 may included an extended lip portion so that the third flange is completely covered by door 24 and the leading edge door gap is fully formed. Again, the present invention should not be viewed as being limited to particular shapes and arrangements of gaps or flanges at the bottom edge of access opening 50, so long as the shape and size of door 24 cooperates with the shape and size of the flange or gap in the manner herein described to create the light-tight seal.

Thus, the light-tight door assembly of the present invention may be translated from the open (raised) to the closed (lowered) position to create the light-tight seal of the present invention. So that the light-tight door assembly 12 stays in the closed position and the light-tight seal remains intact, image assembly 10 may further comprise latch system 34.

In the embodiment shown in FIGS. 2-5 and 8-10, latch system 34 comprises door bracket 52 and a magnetic latch or electromagnetic latch, comprising magnet 54 and support bracket 56. Door bracket 52 is affixed to mounting plate 30. Magnet 54 is affixed to support bracket 56, which in turn is attached to support structure enclosure 14. As can be seen in FIG. 5, door brackets 52 are secured to the mounting plate 30 on either side of door skirt 32; support brackets 56 and magnets 54 are attached to support structure enclosure 14 on either side 60, 62 of access opening 50 at or just below the lower edge of door skirt 32. Although in the embodiment shown, latch system 34 comprises a plurality of door brackets 52, magnets 54 and support brackets 56, other configurations are possible and the invention should not be viewed as being limited in this respect.

Latch system 34 holds light-tight door assembly 12 in the closed position to maintain the light-tight seal when the leading side 40 of door 24 has met the bottom edge of the access opening 50 (e.g., has been received by first gap 66). When magnet 54 is sandwiched between door bracket 52 and support bracket 56, downward force is exerted against the door slides 36, mounting plate 30 and door 24 to a degree sufficient to overcome the upward force exerted against door 24 by counterbalance system 20, which as is explained below, biases the light-tight door assembly 12 in the open position. In one embodiment, latch system secures light-tight door assembly 12 by applying about 25 pounds of downward force against the door slides 36 and mounting plate 30 attached to door 24. Alternatively, other latching devices and systems could be used to hold light-tight door assembly 12 in the closed position.

While latch system 34 holds light-tight door assembly in the closed position, counterbalance system 20 biases light-tight door assembly in a neutral position (i.e., neither open nor closed), for example to easily allow placement of the specimen or wellplate 72 in the imaging chamber 22.

In an embodiment of the present invention as shown in FIGS. 10-14, counterbalance system 20 comprises gas spring assembly 82, including gas spring casing 84, gas spring guide shaft 86 and ball mounting hardware 88. As shown, gas spring assemblies 82 are attached to support structure enclosure 14, as well as to door slides 36 using ball mounting hardware 88. Gas spring casing 84 contains compressed gas, such as dry air, nitrogen, or any other suitable compressed gas; thus, gas spring assembly 82 applies an upward force against door 24 via door slides 36 and mounting plate 30. Counterbalance system 20 may hold light-tight door assembly 12 in a neutral position until a downward or upward force is applied to move door assembly 12 to another position.

In other embodiments, different counterbalance systems 20 may comprise other spring assemblies, counterweight systems or biasing means, as would be familiar to one of ordinary skill in the art after becoming familiar with the teachings of the present invention. The present invention should not be viewed as being limited in that respect.

In an embodiment of the present invention, the light-tight door assembly 12 may also comprise one or more sensors operatively associated with a control system for imaging assembly 10. The sensor(s) may be operatively associated with latch system 34 and configured to signal the control system when light-tight door assembly 12 is secured so that imaging of the specimen may begin in the substantially light-tight environment. The sensor(s) may be continuously or periodically in contact with the control system to alert the control system if door 24 opens for any reason during the imaging process. In another embodiment, sensors in other locations may be used, for example, to monitor any of the second 74, third 76, fourth 78 and fifth 80 gaps between door flange 38 and access opening flange 68, as well as first gap 66, to ensure that they do not become any larger than a predetermined gap width (e.g., about 2.5 mm) while the specimen is being imaged.

In another embodiment of the invention, a control system may be operatively associated with the light-tight door assembly 12 to automate and/or control its translation from the open position to the closed position, and vice versa. In such an embodiment, light-tight door assembly 12 may be equipped with additional sensors for communicating with the control system about the position of door 24. The control system may further comprise operating software, including instructions embedded in the software for opening and closing the door, either automatically according to the embedded instructions, or in response to manual user commands entered in a graphical user interface (GUI) operatively associated with the control system.

In addition to the advantages of maintaining the substantially light-tight environment in imaging chamber 20, the light-tight door assembly 12 of the present invention may also have other advantages. For instance, the vertical orientation of the embodiments as shown in FIGS. 1-11 may be advantageous where laboratory space is at a premium. A light-tight door assembly 12 configured to translate horizontally from the closed position to the open position, and vice versa, would occupy more counter space than the actual dimensions of the image assembly 10 when door 24 is in the open position. In addition to the economy of space it provides, the vertically translating light-tight door assembly 12 may also enhance safety by removing an additional hazard that could protrude into the work space.

Having described the light-tight door assembly 12 in conjunction with the support structure enclosure 14 and the mounting system 18, a method for providing imaging chamber 22 with a substantially light-tight seal will now be described. As discussed above, access opening 50 to imaging chamber 22 is provided with access opening flange 68, a shaped (e.g., C-shaped) flange member that protrudes from top edge 60 and first and second side edges 61, 62 of frame 58. In addition, access opening 50 is provided with a shaped gap (e.g., first gap 66) formed by the space between access opening member 64 and door skirt 32, the shape of first gap 66 being determined by the shape of a cross-section of door 24 it is meant to receive when door is in the closed position. Door 24 is provided with interlocking shaped (e.g., reciprocal C-shaped) door flange 48 positioned to allow the interlocking shaped door flange 48 to be seated cooperatively in relation to the shaped access opening flange 68 without contacting the shaped access opening flange 68 as door 24 begins to close (e.g., when the user pulls down on door handle 28). As the user begins to close light-tight door assembly 12, translating door 24 from open position to the closed position, the interlocking shaped flange (e.g., door flange 38) begins to interlock with the shaped flange (e.g., access opening flange 68), creating at least one gap 74, 76, 78, 80 therebetween. The closing step continues until the at least one gap 74, 76, 78, 80 has been created generally uniformly between the interlocking shaped flange (e.g., door flange 38) and the shaped flange (e.g., access opening flange 68) along the two side edges 61, 62 and the top edge 60 of frame 58 of access opening 50.

In another embodiment, the method may further comprise forming a door gap (e.g., first gap 66) in the support structure enclosure 14 at the bottom edge of access opening 50. As the closing of the light-tight door assembly 12 proceeds, leading side 40 of door 24 is inserted into the door gap (e.g., first gap 66) which has been configured in size and shape to receive reciprocally-shaped door 24. Once leading side 40 of door 24 has been received by the door gap, another substantially light-tight seal is formed at the bottom edge of access opening 50.

In another embodiment, the method may comprise forming a leading edge door gap by virtue of the third flange and the leading side 40 of the door 24, wherein the third flange extends from the bottom edge of access opening 50 into the opening itself. The substantially light-tight seal is formed as door 24 is closed over the third flange forming leading edge door gap.

Embodiments of the method may further comprise maintaining the substantially light-tight seal by securing the light-tight door assembly 12 in the closed position. As explained above, the securing step of the method may be achieved by latching the light-tight door assembly 12 with latch system 34 of the present invention.

In yet another embodiment, the method may comprise using the control system to translate the light-tight door assembly 12 from the open to the closed position, the control system having been equipped with instructions embedded in software for translating the door 24 from the open to the closed position, and vice versa. The method may further comprise causing the control system to open and close the light-tight door assembly 12 automatically or in response to user commands entered in the GUI operatively associated with the control system, as explained above.

Having herein set forth preferred embodiments of the present invention, it is anticipated that suitable modifications can be made thereto which will nonetheless remain within the scope of the invention. The invention shall therefore only be construed in accordance with the following claims:

1. A light-tight door assembly for closing an opening defined in an enclosure, comprising:
a door having at least a leading side and a non-leading side, said door being mounted to said enclosure so that said door can be translated with respect to said opening between an opened position and a closed position;
a first flange member mounted to the non-leading side of said door; and
a second flange member mounted to said enclosure so that said second flange member cooperates with, but does not contact, said first flange member mounted to the non-leading side of said door when said door is in the closed position, the non-contact cooperation of said first and second flange members forming a substantially light-tight seal when said door is in the closed position.

2. The light-tight door assembly of claim 1, wherein at least one gap is formed between said first and second flange members when said door is in the closed position.

3. The light-tight door assembly of claim 2, wherein said gap has a dimension of less than about 2.5 mm (about 0.1 inches).

4. The light-tight door assembly of claim 1, wherein said door comprises a substantially rectangular configuration having first, second, third, and fourth sides, wherein the first side of said door comprises said leading side, and wherein the second, third, and fourth sides of said door comprise respective non-leading sides of said door.

5. The light-tight door assembly of claim 4, wherein said first flange member is mounted to the second, third, and fourth sides of said door, and wherein said second flange member is mounted to said enclosure so that said second flange member cooperates with the first flange member mounted to the second, third, and fourth sides of said door.

6. The light-tight door assembly of claim 1, wherein said first and second flange members comprise C-shaped cross-sections, the C-shaped cross-sections of said first and second flange members being in a nested, non-contact relationship when said door is in the closed position.

7. An assembly, comprising:
an enclosure having at least one opening defined therein;
a guide member mounted to said enclosure;
a door having at least a leading side and a non-leading side mounted to said guide member so that said door can be translated with respect to said at least one opening between an opened position and a closed position;
a first flange extending from the non-leading side of said door; and
a second flange extending from said enclosure so that said second flange cooperates with, but does not contact, said first flange extending from the non-leading side of said door when said door is in the closed position, the non-contact cooperation of said first and second flanges forming a substantially light-tight seal when said door is in the closed position.

8. The assembly of claim 7, wherein said first and second flanges comprise C-shaped cross-sections, the C-shaped cross-sections of said first and second flanges forming a non-contact nested relationship when said door is in the closed position.

9. The assembly of claim 7, wherein a gap is formed between said first and second flanges when said door is in the closed position.

10. The light-tight door assembly of claim 9, wherein said gap has a dimension of less than about 2.5 mm (about 0.1 inches).

11. The assembly of claim 7, wherein the leading side of said door includes an extended lip portion and wherein said enclosure includes a third flange, the extended lip portion on the leading side of said door extending over said third flange when said door is in the closed position so that a leading edge door gap is defined therebetween.

12. The assembly of claim 11, wherein said leading edge door gap has a dimension of less than about 2.5 mm (about 0.1 inches).

13. The assembly of claim 7, wherein said opening has a bottom edge and further comprising:
a first support member extending from the bottom edge of the opening;
a second support member extending from the enclosure, said second support member being in spaced relation to the first support member forming a leading side door gap therebetween, the leading side door gap being configured to receive the leading side of said door forming an additional substantially light-tight seal when said door is in the closed position.

14. The assembly of claim 13, wherein said first support member spans the at least one opening and said second member comprises a door skirt.

15. A method for forming a substantially light-tight seal in an opening defined in an enclosure, comprising:
translating a door with respect to said opening between an open position and a closed position, said door having at least one first flange member operatively associated with a non-leading side of said door, and said enclosure having at least one second flange member operatively associated with said enclosure; and
forming at least one gap between said first flange member and said second flange member when said door is in the closed position so that said gap forms the substantially light-tight seal in said opening defined in said enclosure.

16. The method of claim 15, further comprising forming a leading side door gap in the enclosure, the leading side door gap being configured to receive a leading side of said door so that said leading side door gap forms another substantially light-tight seal when said door is in the closed position.
